(19) United States
(12) Patent Application Publication
(10) Pub. No.: US 2007/0033630 A1
(43) Pub. Date: Feb. 8, 2007

(54) Device, system and method of multi-channel processing

(75) Inventors: David Reznik, Holon (IL); Ilan Rahmany, Tikva (IL)

Correspondence Address: TIAJOLOFF & KELLY, CHRYSLER BUILDING, 37TH FL, 405 LEXINGTON AVE, NEW YORK, NY, 10174, US

(73) Assignee: A.D.I. Video Technologies Ltd., Jerusalem (IL)

(21) Appl. No.: 10/571,156

(22) PCT Filed:
(86) PCT No.: PCT/IL04/00809

Related U.S. Application Data
(60) Provisional application No. 60/501,426, filed on Sep. 10, 2003.

(51) Int. Cl. H04N 7/16; H04N 7/173

(52) U.S. Cl. 725/131; 725/100; 725/139; 725/151

(57) ABSTRACT

Briefly, some embodiments of the invention may include devices, systems and methods of multi-channel processing. For example, a set-top box in accordance with an embodiment of the invention may include a front-end to receive a downstream signal carrying audio/video data representing a first plurality of channels, including one or more scrambled channels; a de-multiplexer to de-multiplex said downstream signal into a second plurality of channels including at least one of said one or more scrambled channels; a descrambler to descramble said one or more scrambled channels into one or more, respective, descrambled channels; a bouquet producer to receive said second plurality of channels and said one or more descrambled channels and produce a bouquet including said second plurality of channels and said one or more descrambled channels; a multiplexer to receive said bouquet and produce an output signal carrying audio/video data representing said second plurality of channels, including said one or more de-scrambled channels; and an output unit to provide said output signal to one or more audio/video devices.

### PRIOR APPLICATION DATA

The present application claims priority and benefit from prior U.S. Provisional Patent Application No. 60/501,426, entitled “Multi-channel STB-MSTB”, filed on Sep. 10, 2003 and incorporated herein by reference.

### FIELD OF THE INVENTION

The present invention relates to the field of set-top boxes for cable or satellite television systems.

### BACKGROUND OF THE INVENTION

A residence may include a plurality of television sets or other AudioNideo (A/V) devices able to receive incoming A/V data, e.g., from a cable television provider or a satellite television provider. The incoming A/V data may be pre-scrambled, requiring each of the televisions in the residence to be connected to a Set-Top Box (STB) having a decryptor unit, e.g., a SmartCard.

### SUMMARY OF THE INVENTION

Some embodiments of the invention may include, for example, a Multi-channel Set-Top Box (MSTB) able to receive A/V data representing a plurality of television channels, optionally de-scramble one or more of the television channels, and, based on user selection, create a bouquet of selected channels for distribution or delivery to remote and local television sets and/or other A/V devices.

In accordance with some embodiments of the invention, the MSTB may, for example, receive an incoming or downstream signal carrying A/V data representing a first number of channels. The MSTB may process the received signal to produce a signal carrying data representing a second, different, number of channels, e.g., an equal or smaller number of user-selected channels, optionally including one or more de-scrambled channels.

In accordance with some embodiments of the invention, the MSTB may, for example, separate one or more channels from the plurality of channels of the incoming or downstream signal, optionally de-scramble data in one or more of the received channels, produce a combined bouquet incorporating the separated channels, multiplex the combined bouquet of channels, and distribute, deliver, transmit, transfer or otherwise provide the multiplexed bouquet to one or more local and/or remote televisions and/or A/V devices.

In accordance with some embodiments of the invention, the MSTB may include, for example, a front-end to receive a downstream signal carrying audio/video data representing a first plurality of channels, including one or more scrambled channels; a de-multiplexer to de-multiplex said downstream signal into a second plurality of channels including at least one of said one or more scrambled channels; a descrambler to descramble said one or more scrambled channels into one or more, respective, descrambled channels; a bouquet producer to receive said second plurality of channels and said one or more descrambled channels and produce a bouquet including said second plurality of channels and said one or more descrambled channels; a multiplexer to receive said bouquet and produce an output signal carrying audio/video data representing said second plurality of channels, including said one or more descrambled channels; and an output unit to provide said output signal to one or more audio/video devices.

In accordance with some embodiments, the processing operations performed by the MSTB may be performed based on user input, for example, based on a received selection command entered by a user through a remote control unit.

In accordance with some embodiments, the processing operations performed by the MSTB may optionally include, for example, encrypting one or more channels, Control Words (CWs) or data items, e.g., for secure distribution of data within a predefined residence or location.

In accordance with some embodiments, the processing operations performed by the MSTB may optionally include, for example, analyzing, creating, updating or modifying one or more tables, e.g., to support a plurality of services. This may include, for example, analyzing data, a Program Association Table (PAT) and/or a Program Map Table (PMT), e.g., to identify one or more Packet Identifier Descriptors (PIDs). Based on the identified PIDs, the MTSB may modify, update or generate a Conditional Access Program Map Table (CA-PMT), e.g., to create a CA-PMT which may include the identified PIDs, thereby allowing the re-multiplexed signal to carry de-scrambled data or other CA content.

In accordance with some embodiments, the processing operations performed by the MSTB may optionally include, for example, analyzing the incoming signal, de-scrambling a CW included in the data carried by the signal, and embedding the de-scrambled CW in an Entitled Control Module (ECM) or an Entitled Manager Module (EMM) in the re-multiplexed signal.

In accordance with some embodiments, the processing operations performed by the MSTB may optionally include, for example, monitoring and/or analyzing data related to network traffic, bandwidth allocation, bandwidth use, data traffic, or data transfer rates. Based on the monitoring and/or analysis, optimizing operations may be performed, for example, by optimizing a data item or modifying a property of a data item to be sent by the MSTB, e.g., to allow or achieve a pre-defined Quality of Service (QoS).

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of an Audio/Video (A/V) system including a Multi-channel Set-Top Box (MSTB) in accordance with some exemplary embodiments of the invention;

FIG. 2 is a schematic block diagram illustration of a MSTB in accordance with an exemplary embodiment of the invention;

FIG. 3 is a schematic block diagram illustration of a MSTB in accordance with another exemplary embodiment of the invention;

FIG. 4 is a schematic block diagram illustration of a MSTB operatively connected to a local A/V device and a remote device in accordance with exemplary embodiments of the invention; and

FIG. 5 is a schematic flow-chart of a method of method of multi-channel processing in accordance with exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

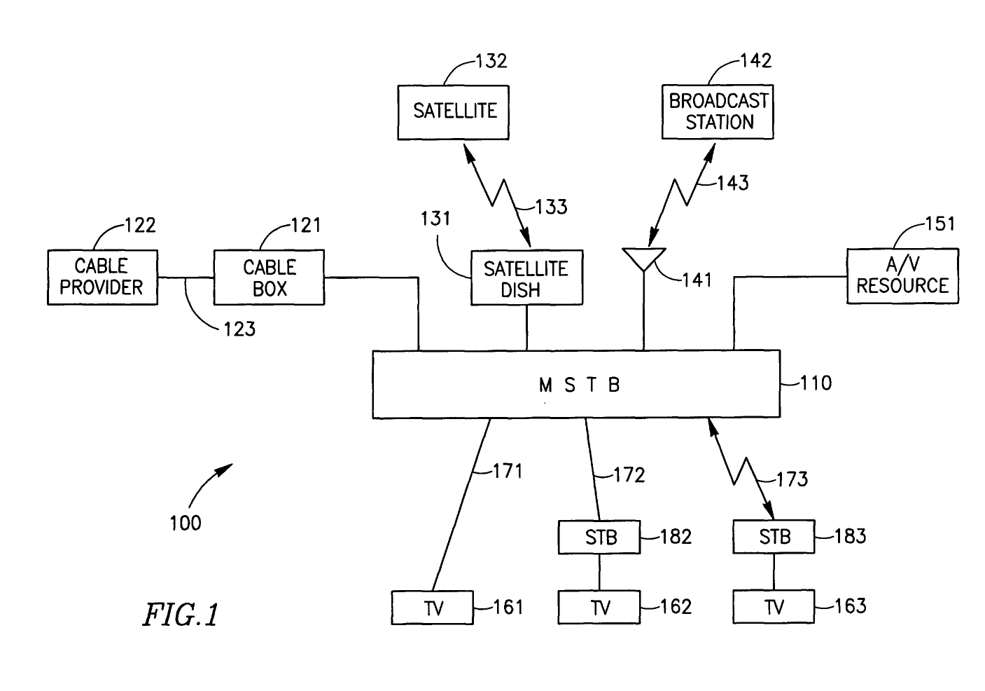

FIG. 1 schematically illustrates a block diagram of an audio/video (A/V) system 100 including a Multi-channel Set-Top Box (MSTB) 110 in accordance with some exemplary embodiments of the invention.

System 100 may include one or more devices or units able to receive A/V signals from various sources, and/or one or more devices able to produce A/V signals. For example, system 100 may include a cable box 121 able to receive signals carrying A/V data from a cable provider box 122 through a cable 123. Additionally or alternatively, system 100 may include, for example, a dish 131 able to receive wireless signals carrying A/V data from a satellite 132 through a wireless link 133. Additionally or alternatively, system 100 may include, for example, an antenna 141 able to receive wireless signals carrying A/V data from a broadcast station 142 through a wireless link 143. Additionally or alternatively, system 100 may include other A/V receivers or resources 151, for example, a Digital Versatile Disk (DVD) player, a Video Cassette Recorder (VCR), a Digital Video Recorder (DVR), a Personal Computer (PC), a computing platform, a gaming device, a network gaming device, a video server, a video conference device, a remote learning device, an A/V camera, a device connected to the Internet or the World Wide Web, or the like. Although four sources of A/V data are shown in FIG. 1, embodiments of the present invention are not limited in this regard, and may include one A/V source or another number of A/V sources.

MSTB 110 may be connected, through wired or wireless links, to one or more A/V resources, e.g., to cable box 121, to dish 131, to antenna 141, and/or to A/V resources 151. MSTB 110 may receive from these A/V resources signals carrying A/V data. The incoming signal may carry data representing a plurality of content items, for example, a plurality of content items known as “television channels” or “television programs”, e.g., fifty television channels. MSTB 110 may produce an outgoing signal which may carry data representing one or more content items, e.g., three television channels, which may be transferred to a plurality of local and/or remote televisions.

In one embodiment, for example, MSTB 110 may receive from cable box 121 an incoming or a downstream signal carrying A/V data representing a plurality of television channels. MSTB 110 may, for example, de-scramble at least one of the received channels. MSTB 110 may process, demultiplex and remultiplex the received signal. In one embodiment, MSTB 110 may generate and send to television 161 a first signal carrying A/V data representing a first channel, may generate and send to television 162 a second signal carrying A/V data representing a second, different, channel, and may generate and send to television 163 a third signal carrying A/V data representing a third, different, channel. In an alternate embodiment, MTSB 110 may generate and send to televisions 161, 162 and/or 163 a signal carrying data representing the first, the second and the third channels.

For example, MSTB 110 may transfer the processed signals to a television 161 through a wired link 171, to a television 162 through a wired link 172 and optionally a Set-Top Box (STB) 182, and to a television 163 through a wireless link 163 and optionally a STB 183. In some embodiments, for example, STB 182 and/or STB 183 may not include a SmartCard or a decryptor unit. Although three television units are shown in FIG. 1, embodiments of the present invention are not limited in this regard, and may include one television unit, another number television units, one A/V receiver unit, or another number of television units and/or A/V receiver units.

In some embodiments, links 171, and/or 173 may optionally include a return link, allowing a user of televisions 161, 162 and/or 163, respectively, to select a television channel, e.g., using a user interface or a remote control unit associated with one or more of televisions 161, 162 and 163.

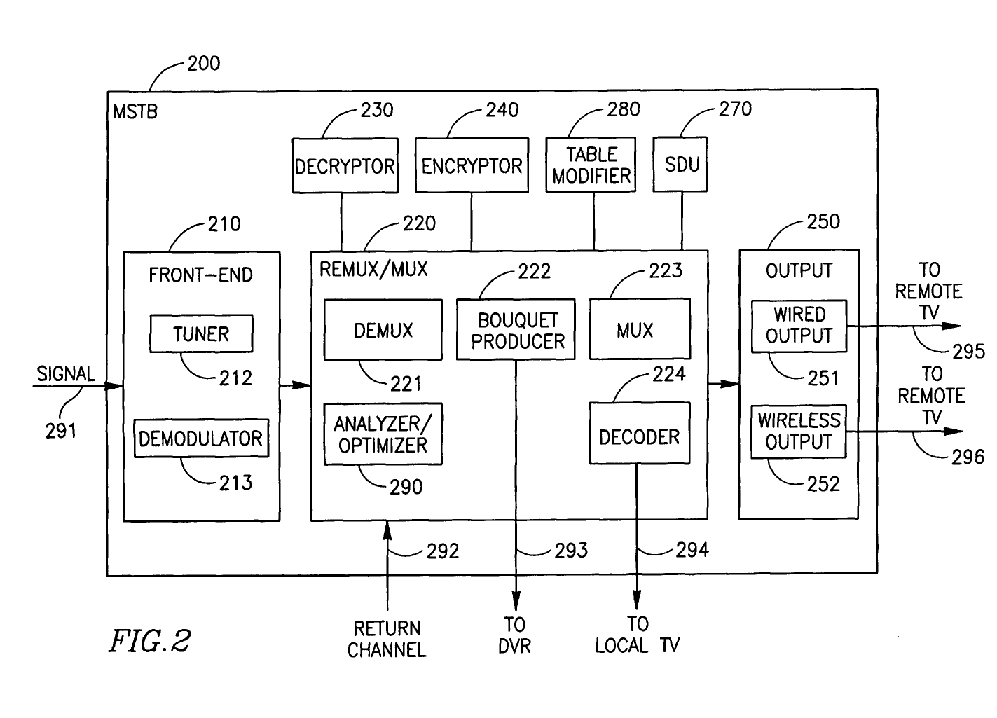

FIG. 2 schematically illustrates a block diagram of a MSTB 200 in accordance with exemplary embodiments of the invention. MSTB 200 may be an example of MSTB 110 of FIG. 1. MSTB 200 may include, for example, a front-end 210, a Remux/Mux unit 220, and an output interface 250. MSTB 200 may optionally include, for example, a descrambler or decryptor 230 and an encryptor 240. The components of MSTB 200 may be implemented, for example, using hardware components and/or software components.

Front-end 210 may include one or more modules or units able to receive one or more signals representing a plurality of channels, e.g., an incoming signal or a downstream signal. For example, front-end 210 may include one or more one or more tuners 212, one or more multi-channel demodulators 213, or a plurality of tuners and/or demodulators. Front-end 210 may include, for example, a module able to receive Quadrature Amplitude Modulation (QAM) signals from a cable signals provider, a module able to receive Quadrature Phase Shift Keying (QPSK) signals or 8-Phase Shift Keying (8PSK) signals from a satellite signals provider, a module able to receive terrestrial signals from a television broadcast company, a module able to receive Digital Subscriber Line (DSL) signals from a telephony provider, or other modules. Front-end 210 may be implemented, for example, using a plurality of independent modules or using one or more multi-function modules.

As indicated by arrow 291, front-end 210 may receive an incoming signal carrying A/V data, which may be transferred to Remultiplexer/Multiplexer (Remux/Mux) 220. Remux/Mux 220 may include, for example, Demultiplexer (Demux) 221, a bouquet producer 222, a Multiplexer (Mux) unit 223, and optionally a decoder 224. Remux/Mux 220 may receive from front-end 210 a signal carrying data representing a first number of channels, e.g., fifty channels, and may produce a signal carrying data representing a second, e.g., smaller, number of channels, for example, three channels. In some embodiments, as indicated by arrow 292, this may be performed based on user input received through a return channel or return link, allowing a user to select the three channels from the fifty available channels.

In some embodiments, for example, Remux/Mux 220 may receive from front-end 210 the signal carrying A/V data representing the plurality of channels, for example, fifty channels. Demux 221 may separate one or more channels, for example, three channels, from the plurality of channels of the incoming A/V signal. The three separated channels may be transferred to bouquet producer 222, which may produce a combined bouquet incorporating the three channels. The combined bouquet may be transferred to Mux 223, which may multiplex the combined bouquet, e.g., by adding or creating system layers.

The multiplexed signal may be transferred from Remux/Mux 220 to an output interface 250. Output interface 250 may include one or more wired output ports 251, e.g., an output socket or terminal able to transfer the signal to a remote television or receiver through a wired link as indicated by arrow 295. Additionally or alternatively, output interface 250 may include one or more wireless output ports 252, e.g., a transmitter or transceiver able to transmit the signal to a remote television or receiver through a wireless link as indicated by arrow 296.

Optionally, as indicated by arrow 293, bouquet producer 222 of Remux/Mux 220 may transfer a signal carrying data representing one of the three channels to a recorder, e.g., to a Digital Video Recorder (DVR) or to a Hard Disk Drive (HDD) in a digital format. In one embodiment, the recorder may be an external unit or a dedicated device, e.g., an external DVR or HDD. In an alternate embodiment, the recorder may be an internal unit of MSTB 200 or an integrated part connected to or embedded within MSTB 200.

Optionally, decoder 224 of Remux/Mux 220 may decode the multiplexed signal produced by Remux/Mux 220 to produce A/V data representing one of the three channels. As indicated by arrow 294, decoder 204 may transfer the decoded data to a local television or receiver, e.g., to a television which may be directly or closely connected to MSTB 200.

Optionally, Remux/Mux 220 may be operatively connected to descrambler or decryptor 230, which may include, for example, one or more SmartCards or decrypting units. Decryptor 230 may decrypt or descramble data processed by Remux/Mux 220, thereby allowing Remux/Mux 220 to process pre-encrypted or pre-scrambled channels or A/V data.

Optionally, Remux/Mux 220 may be operatively connected to encryptor 240, which may perform decryption operations, for example, to allow Remux/Mux 220 to transfer out a signal carrying encrypted data representing the three channels, e.g., for transmittal to a remote television.

Optionally, Remux/Mux 220 may be operatively connected to, or may include, a table modifier 280 allowing Remux/Mux 220 to process one or more channels which may be pre-scrambled or which may include a Conditional Access (CA) data item, e.g., a channel available only upon payment. Table modifier may include, for example, hardware components and/or software components able to analyze and modify one or more data tables which may be used by Remux/Mux 220, included in signals received by Remux/Mux 220, or included in signals produced by Remux/Mux 220. For example, table modifier 280 may analyze Program Specific Information (PSI) data, a Program Association Table (PAT) and/or a Program Map Table (PMT) to identify one or more Packet Identifier Descriptors (PIDs). Based on the identified PIDs, table modifier 280 may modify, update or generate a Conditional Access Program Map Table (CA-PMT), e.g., to create a CA-PMT which may include the identified PIDs, allowing a multiplexed signal to carry de-scrambled data or other CA content. It one embodiment, this may further allow to de-scramble a plurality of A/V streams from a plurality of service providers, obviating a need for additional SmartCards or decryptors other than decryptor 230.

Optionally, Remux/Mux 220 may be operatively connected to, or may include, a Secure Distribution Unit (SDU) 270 allowing MSTB 200 to produce a signal carrying scrambled data, e.g., for secure distribution or delivery of the multiplexed signal to one or more remote televisions. In one embodiment, for example, a channel bouquet produced by bouquet producer 222 may include a bouquet of originally pre-scrambled channels, thereby obviating the need to re-scramble data in the MSTB 200. Further, MSTB 200 may analyze an incoming signal and may de-scramble a Control Word (CW) included in the data carried by the signal, e.g., using decryptor 230. While the CW is valid, SDU 270 may embed the de-scrambled CW in an Entitled Control Module (ECM) or an Entitled Manager Module (EMM) which may be included in the multiplexed signal sent by MSTB 200 to one or more remote televisions. The ECM or EMM may be, for example, a unique or proprietary ECM or EMM, respectively, e.g., a unique data item per a plurality of televisions in a residency. In one embodiment, for example, SMTB 200 may de-scramble a plurality of CWs corresponding to a plurality of user-selected channels, and may include the de-scrambled CWs in the produced multiplexed signal. This may allow, for example, distribution of received secured programs without a need for a SmartCard or a decryptor in remote televisions.

Optionally, Remux/Mux 220 may be operatively connected to, or may include, a statistical analyzer/optimizer 290. Analyzer/optimizer 290 may monitor traffic and data transfers in a network connected to SMTB 200, e.g., between SMTB 200 and remote televisions through wireless links. Analyzer/optimizer 290 may collect data related to data transfer, e.g., data transfer rates and bandwidth usage, and may analyze the data in order to optimize data transfer across the network or from SMTB 200. For example, analyzer/optimizer 290 may optimize a data item or may modify a property of a data item to be sent by SMTB 200, e.g., based on an available bandwidth allocated to a transfer of that data item, or allocated to a remote television for receiving the data item from SMTB 200. In one embodiment, Remux/Mux 220 and statistical analyzer/optimizer 290 may be integrated as one unit, e.g., as a statistical Remux/Mux unit.

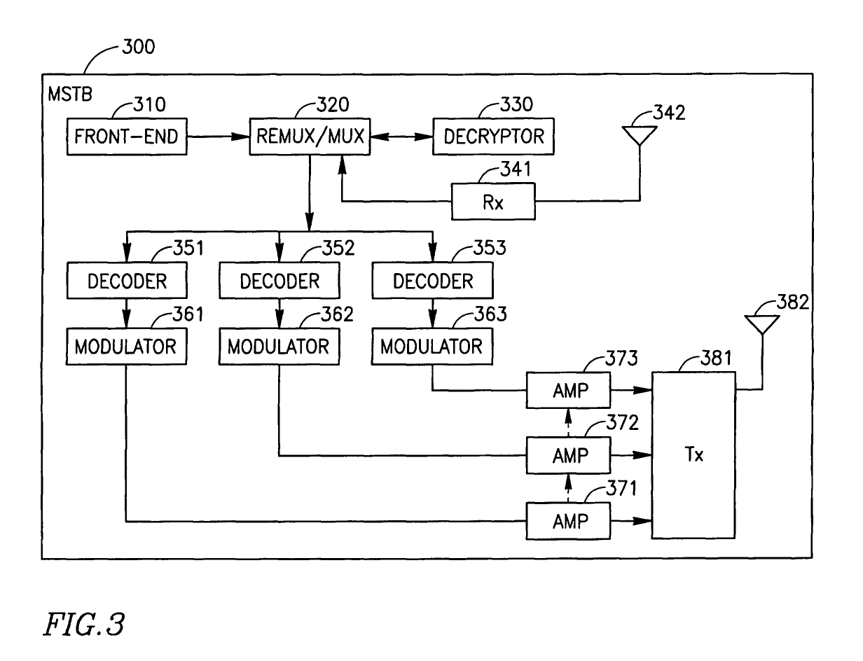

FIG. 3 schematically illustrates a block diagram of a MSTB 300 in accordance with exemplary embodiments of the invention. MSTB 300 may be an example of MSTB 110 of FIG. 1 or of MSTB 200 of FIG. 2. MSTB 300 may include, for example, a front-end 310, a Remux/Mux 320, and a decryptor 330, which may be similar to front-end 210, Remux/Mux unit 220, and decryptor 230, respectively, of FIG. 2. MSTB 300 may further include a receiver 341 connected to an antenna 342, to receive wireless communication signals, e.g., signals indicating user commands entered through a remote control unit, for example, for selecting a television channel.

Front-end 310 may receive an incoming or downstream signal carrying data representing a plurality of television channels, from which Remux/Mux 320 may produce a multiplexed bouquet of selected channels, optionally after de-scrambling one or more data items or channels using decryptor 330. The multiplexed bouquet may be transferred to a plurality of decoders, for example, three decoders 351, 352 and 353, which may be similar to decoder 224 of FIG. 2. Decoders 351, 352 and 353 may decode and produce data representing a first channel, a second channel and a third channel, respectively, from the received bouquet. The data representing the first, second and third channels may be transferred from decoders 351-353 to a plurality of modulators 361-363, respectively, for modulation, e.g., into Very High Frequency (VHF) or Ultra High Frequency (UHF). Optionally, the modulated signals may be amplified and/or combined, for example, using amplifiers 371-373. The modulated signals may be transmitted, for example, using a wireless transmitter 381 and an antenna 382, and may be received, for example, by a remote television or by a remote STB connected to a remote television.

MSTB 300 may include other suitable hardware components and/or software components, for example, a wired output unit. It is noted that although three decoders, modulators and amplifiers are shown in FIG. 3, the present invention is not limited in this regard, and MSTB 300 may include other suitable number of decoders, modulators and/or amplifiers.

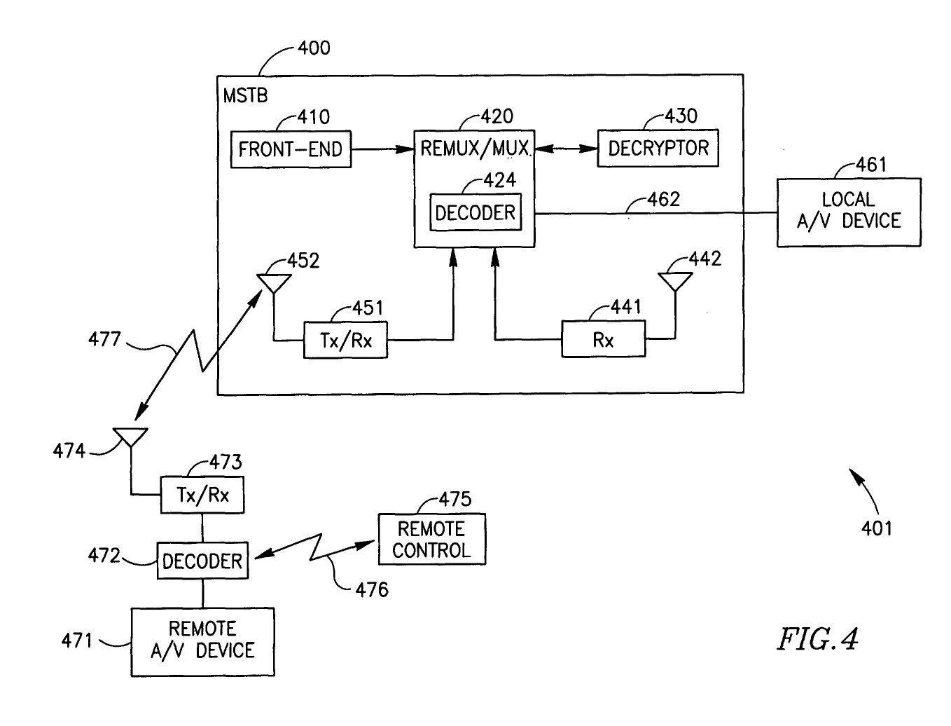

FIG. 4 schematically illustrates a block diagram of a system 401 including a MSTB 400 operatively connected to a local A/V device 461 and a remote A/V device 471 in accordance with exemplary embodiments of the invention. System 401 may be an example of system 100 of FIG. 1, and MSTB 400 may be an example of MSTB 110 of FIG. 1 or of MSTB 200 of FIG. 2.

MSTB 400 may include, for example, a front-end 410, a Remux/Mux 420, and a decryptor 430, which may be similar to front-end 210, Remux/Mux unit 220, and decryptor 230, respectively, of FIG. 2. MSTB 400 may further include a receiver 441 connected to an antenna 442, to receive wireless communication signals, e.g., signals indicating user commands entered through a remote control unit, for example, for selecting a television channel.

Front-end 410 may receive an incoming or downstream signal carrying data representing a plurality of television channels, from which Remux/Mux 420 may produce a multiplexed bouquet of selected channels, optionally after de-scrambling one or more data items or channels using decryptor 430. One or more channels of the bouquet may be decoded, for example, using one or more decoders 424, e.g., which may be integrated within Remux/Mux 420.

Data of a first decoded channel may be transferred out of MSTB 400, for example, to local A/V device 461 through a wired link 462. Local A/V device 461 may include, for example, a television able to receive A/V signals, a PC able to receive A/V signals and exchange other data with MSTB 400, or other suitable A/V units.

Additionally or alternatively, data of a second, different or identical, decoded channel may be transferred out of MSTB 400, for example, to remote A/V device 471 using a wireless connection. For example, MSTB 400 may include a wireless transceiver 451 connected to an antenna 452, allowing MSTB 400 to transmit wireless signals to a remote wireless transceiver 473 connected to a remote antenna 474. The remote transceiver 473 may be connected to, or may be part of, a decoder unit 472 which may not include a decryptor or a SmartCard, and may be connected to, or may be part of, remote A/V device 471 or a STB connected to remote A/V device 471. Decoder 475 may further be able to receive signals from a remote control unit 475, for example, through a wireless link 476. Decoder 475 may receive from MSTB 400 one or more channels, for example, a channel decrypted using decryptor 430 of MSTB 400. Decoded data may be transferred from decoder 424 to remote A/V device. Remote A/V device 471 may include, for example, a television able to receive A/V signals from decoder 424, a PC able to receive A/V signals and exchange other data with decoder 424, or other suitable A/V units.

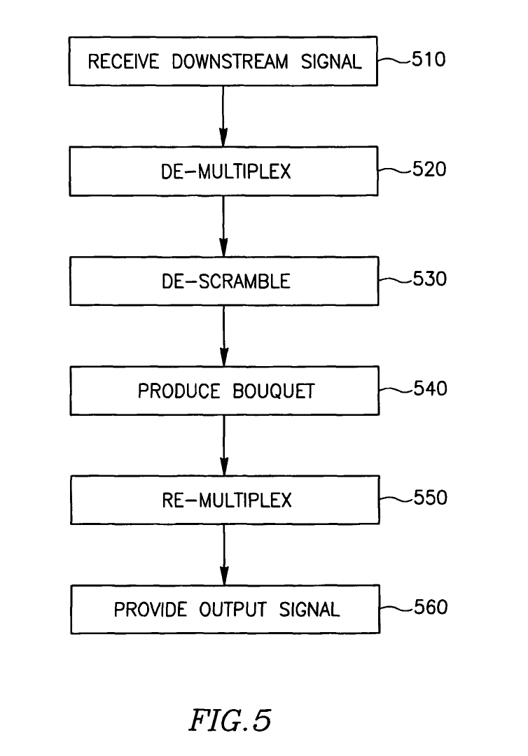

FIG. 5 is a schematic flow-chart of a method of multi-channel processing in accordance with exemplary embodiments of the invention. The method may be used, for example, by system 100 of FIG. 1, by MSTB 110 of FIG. 1, by MSTB 200 of FIG. 2, by MSTB 300 of FIG. 3, by MSTB 400 of FIG. 4, by system 401 of FIG. 4, or by other suitable devices or systems.

As indicated at box 510, the method may begin, for example, by receiving an incoming or downstream signal carrying A/V data representing a first plurality of channels, including one or more scrambled channels. This may be performed, for example, by front-end 210 of FIG. 2.

As indicated at box 520, the method may include, for example, de-multiplexing said downstream signal into a second plurality of channels including at least one of said one or more scrambled channels. This may be performed, for example, by Demux 221.

As indicated at box 530, the method may include, for example, descrambling said one or more scrambled channels into one or more, respective, descrambled channels. This may be performed, for example, by decryptor 230.

As indicated at box 540, the method may include, for example, receiving said second plurality of channels and said one or more descrambled channels and producing a bouquet including said second plurality of channels and said one or more descrambled channels. This may be performed, for example, by bouquet producer 222.

As indicated at box 550, the method may include, for example, receiving said bouquet and re-multiplexing it to produce an output signal carrying audio/video data representing said second plurality of channels, including said one or more descrambled channels. This may be performed, for example, by Mux 223.

In some embodiments, optionally, the method may perform one or more of the above-mentioned operations based on user input, for example, based on a received selection command through a remote control unit.

In some embodiments, optionally, the method may include, for example, encrypting one or more channels, CWs or data items, e.g., using encryptor 240 for secure distribution of data.

In some embodiments, optionally, the method may include, for example, analyzing, creating, updating or modifying one or more tables, e.g., to support a plurality of services. This may include, for example, analyzing data, a PAT and/or a PMT to identify one or more PIDs, and, based on the identified PIDs, may modifying, updating or generating a CA-PMT.

In some embodiments, optionally, the method may include, for example, analyzing the incoming signal, de-scrambling a CW included in the data carried by the signal, and embedding the de-scrambled CW in an ECM or an EMM included in the multiplexed signal. This may be performed, for example, by SDU 270.

In some embodiments, optionally, the method may include, for example, monitoring and/or analyzing data related to network traffic, bandwidth allocation, bandwidth use, data traffic, or data transfer rates. Based on the monitoring and/or analysis, optimizing operations may be performed, for example, by optimizing a data item or modifying a property of a data item to be sent by MSTB 200.

As indicated at box 560, the method may include, for example, providing, transferring or transmitting said output signal to one or more A/V devices. This may be performed, for example, by output unit 250, e.g., using one or more wired and/or wireless links.

Other suitable operations or sets of operations may be used in accordance with embodiments of the invention.

Some embodiments of the invention may operate in accordance with a pre-defined protocol or standard, or may be used in conjunction with devices, data or broadcasts which may be in accordance with a pre-defined protocol or standard. Such protocol or standard may include, for example, Digital Video Broadcast (DVB) protocols or standards, Advanced Television Systems Committee (ATSC) protocols or standards, or other suitable protocols or standards.

Some embodiments of the invention may be used in conjunction with, or may process, signals in a digital format and/or in an analog format. Some embodiments of the invention may transfer data, transmit data and/or receive data using one or more wired links and/or wireless links, e.g., wireless links in accordance with a pre-defined wireless communication protocol or standard. Such protocol or standard may include, for example, 802.11, 802.11a, 802.11b, 802.11g, 802.11n, 802.16, Wireless Fidelity (Wi-FI), WiMAX, Bluetooth, Ultra Wide Band (UBW), or existing and/or future versions of similar protocols or standards.

Although some embodiments of the invention are presented herein, for exemplary purposes, in the context of a Set-Top Box (STB) or a Mutli-channel STB (MSTB), the present invention is not limited in this regard, and may be used or implemented in various other devices, consoles, units or apparatuses. For example, some embodiments of the invention may be implemented as, or may be used in, an Integrated Receiver Decoder (IRD) device or an Internet Protocol (IP) decoder device, a professional or industrial video processing device or console, a video server or a device able to communicate with a video server, a high-end or high-quality A/V processing device, an A/V processing device or system used in an A/V editing or processing studio, and other residential, industrial or professional devices and systems.

Some embodiments of the invention may be implemented, for example, using one or more general and/or specific hardware components and/or software components. In some embodiments, MSTB 110 of FIG. 1, MSTB 200 of FIG. 2, Remux/Mux 220 of FIG. 2, MSTB 300 of FIG. 3, Remux/Mux 320 of FIG. 3, MSTB 400 of FIG. 4, or Remux/Mux 420 of FIG. 4, may include or be implemented as, for example, a controller, a processor, a micro-processor, a chip, a Central Processing Unit (CPU), a Digital Signal Processor (DSP), a circuit, an Integrated Circuit (IC), or the like.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by MSTB 110 of FIG. 1, by MSTB 200 of FIG. 2, by MSTB 300 of FIG. 3, by MSTB 400 of FIG. 4, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A set-top box comprising:
a front-end to receive a downstream signal carrying audio/video data representing a first plurality of channels, including one or more scrambled channels;
a de-multiplexer to de-multiplex said downstream signal into a second plurality of channels including at least one of said one or more scrambled channels;
a descrambler to descramble said one or more scrambled channels into one or more, respective, descrambled channels;
a bouquet producer to receive said second plurality of channels and said one or more descrambled channels and produce a bouquet including said second plurality of channels and said one or more descrambled channels;
a multiplexer to receive said bouquet and produce an output signal carrying audio/video data representing said second plurality of channels, including said one or more descrambled channels; and
an output unit to provide said output signal to one or more audio/video devices.

2. The set-top box of claim 1, comprising a transmitter to transmit said output signal.

3. The set-top box of claim 1, comprising an output port able to transfer said output signal.

4. The set-top box of claim 1, wherein said descrambler comprises one or more SmartCards.

5. The set-top box of claim 1, comprising a table modifier to create a Conditional Access Program Map Table.

6. The set-top box of claim 1, comprising a table modifier to update a Conditional Access Program Map Table based on one or more Packet Identifier Descriptors.

7. The set-top box of claim 1, wherein said set-top box is able to analyze said downstream signal, to de-scramble a Control Word carried by said downstream signal, and to embed said Control Word in said output signal.

8. The set-top box of claim 7, wherein said set-top box is able to embed said Control Word in an Entitled Control Module in said output signal.

9. The set-top box of claim 7, wherein said set-top box is able to embed said Control Word in an Entitled Manager Module in said output signal.

10. The set-top box of claim 1, wherein said set-top box is able to analyze data traffic in a network connected to said set-top box.

11. The set-top box of claim 10, wherein said set-top box is able to modify a data item carried by said output signal based on an analysis of said data traffic.

12. The set-top box of claim 1, comprising an encryptor to encrypt a data item, carried by said bouquet including said second plurality of channels and said one or more descrambled channels, into an encrypted data item, and to include said encrypted data item in said output signal.

13. The set-top box of claim 1, wherein said set-top box is able to select said second plurality of channels of channels from said first plurality of channels based on a signal indicating a user selection of at least one of said second plurality of channels.

14. A system comprising:
a set-top box comprising:
a front-end to receive a downstream signal carrying audio/video data representing a first plurality of channels, including one or more scrambled channels;
a de-multiplexer to de-multiplex said downstream signal into a second plurality of channels including at least one of said one or more scrambled channels;
a descrambler to descramble said one or more scrambled channels into one or more, respective, descrambled channels;
a bouquet producer to receive said second plurality of channels and said one or more descrambled channels and produce a bouquet including said second plurality of channels and said one or more descrambled channels;
a multiplexer to receive said bouquet and produce an output signal carrying audio/video data representing said second plurality of channels, including said one or more descrambled channels; and
an output unit to provide said output signal to one or more audio/video devices, and
an audio/video device to receive said output signal from said set-top box.

15. The system of claim 14, wherein said set-top box comprises a transmitter to transmit said output signal to said audio/video device.

16. The system of claim 14, wherein said set-top box comprises an output port to transfer said output signal to said audio/video device.

17. The system of claim 14, wherein said audio/video device comprises a television.

18. The system of claim 14, wherein said audio/video device comprises a personal computer.

19. A method comprising:
receiving a downstream signal carrying audio/video data representing a first plurality of channels, including one or more scrambled channels;
de-multiplexing said downstream signal into a second plurality of channels including at least one of said one or more scrambled channels;
descrambling said one or more scrambled channels into one or more, respective, descrambled channels;
producing a bouquet including said second plurality of channels and said one or more descrambled channels;
receiving said bouquet and producing an output signal carrying audio/video data representing said second plurality of channels, including said one or more descrambled channels; and
providing said output signal to one or more audio/video devices.

20. The method of claim 19, wherein said providing comprises transmitting said output signal through a wireless communication link.

21. The method of claim 19, wherein said providing comprises transferring said output signal through a wired link.

22. An integrated receiver decoder comprising:
a front-end to receive a downstream signal carrying audio/video data representing a first plurality of channels, including one or more scrambled channels;
a de-multiplexer to de-multiplex said downstream signal into a second plurality of channels including at least one of said one or more scrambled channels;
a descrambler to descranble said one or more scrambled channels into one or more, respective, descrambled channels;
a bouquet producer to receive said second plurality of channels and said one or more descrambled channels and produce a bouquet including said second plurality of channels and said one or more descrambled channels;
a multiplexer to receive said bouquet and produce an output signal carrying audio/video data representing said second plurality of channels, including said one or more descrambled channels; and
an output unit to provide said output signal to one or more audio/video devices.

23. The integrated receiver decoder of claim 22, wherein said integrated receiver decoder is able to analyze said downstream signal, to de-scramble a Control Word carried by said downstream signal, and to embed said Control Word in said output signal.

24. The integrated receiver decoder of claim 23, wherein said integrated receiver decoder is able to embed said Control Word in an Entitled Control Module in said output signal.

25. The integrated receiver decoder of claim 23, wherein said integrated receiver decoder is able to embed said Control Word in an Entitled Manager Module in said output signal.

26. The integrated receiver decoder of claim 22, wherein said integrated receiver decoder is able to analyze data traffic in a network connected to said integrated receiver decoder.

27. The integrated receiver decoder of claim 26, wherein said integrated receiver decoder is able to modify a data item carried by said output signal based on an analysis of said data traffic.

28. The integrated receiver decoder of claim 22, comprising an encryptor to encrypt a data item, carried by said bouquet including said second plurality of channels and said one or more descrambled channels, into an encrypted data item, and to include said encrypted data item in said output signal.
